(19) United States
(12) Patent Application Publication
(10) Pub. No.: US 2025/0296477 A1
(43) Pub. Date: Sep. 25, 2025

(54) ROUTE BASED THERMAL MANAGEMENT SYSTEM

(71) Applicant: Caterpillar Inc., Peoria, IL (US)

(72) Inventors: Xinqiang XU, Dunlap, IL (US); Xinyu GE, Peoria, IL (US); Hua XU, Dunlap, IL (US); Siyi ZHOU, Dunlap, IL (US)

(73) Assignee: Caterpillar Inc., Peoria, IL (US)

(21) Appl. No.: 18/610,445

(22) Filed: Mar. 20, 2024

(51) Int. Cl. B60L 58/25; B60L 50/40; B60L 50/60

(52) U.S. Cl. CPC B60L 58/25; B60L 50/40; B60L 50/60; B60L 2200/36; B60L 2240/12; B60L 2240/26; B60L 2240/545; B60L 2240/642

(57) ABSTRACT

A system and method for regulating an operating temperature of an energy storage system configured to provide power to a vehicle. The system may comprise a TMS and a controller. The controller may be configured to receive route information, vehicle speed and/or payload and determine aggregate power demand and aggregate regeneration energy, and estimated charging/discharging current. The controller may be furthered configured to initiate a ramp-up procedure based on the estimated discharging current associated with the next sequential incoming segment and a preparation time, and/or to initiate a ramp-up procedure based on the estimated charging current associated with the next sequential incoming segment and a preparation time.

### TECHNICAL FIELD

The present disclosure generally relates to energy storage management systems, and more particularly, to battery or capacitor management systems used on construction, mining and other industrial vehicles.

### BACKGROUND

In battery-powered machines it is desirable to regulate battery operation temperature to achieve the desired performance and mitigate risks. This presents challenges, as battery charging is endothermic and battery discharging is exothermic. When discharging, excess heating and thermal runaway can be a concern. To regulate battery operation temperature a Battery Thermal Management System (BTMS) may be utilized for a vehicle/machine

Most BTMSs use closed-loop control with a targeted battery temperature based on battery pack “skin” surface temperature or cell temperature. This control is responsive control. However, it takes time for the battery pack's skin temperature to increase. By the time a traditional BTMS detects the temperature change and starts adjusting the output of the compressor of the refrigeration circuit, the battery-powered machine may get onto a different segment of the route and load conditions change, impacting cooling needs. Considering BTMS design, it also takes time for the chiller to take away the rejected heat via heat transfer. In summary, there is a time delay between heat generation inside a battery pack and BTMS response.

U.S. Pat. No. 9,809,214, issued May 5, 2015, (the '214 patent) describes a vehicle that includes an engine and at least one controller. A first engine cycling command based on route information and a second engine cycling command independent of route information are generated. The engine transitions state according to the first engine cycling command when the second engine cycling command permits the transition. When a first engine cycling profile based on route information includes at least a number of engine cycles, the engine is cycled according to the first engine cycling profile, otherwise, the engine is cycled according to an engine cycling state derived independent of route information. The vehicle includes a traction battery. A state of charge of the traction battery is controlled according to a target state of charge that is derived using route information and a base battery power reference that is independent of route information. A better solution is desired.

### SUMMARY OF THE DISCLOSURE

In one aspect of the present disclosure, a method of regulating a temperature of an energy storage system configured to provide power to a vehicle is disclosed. The energy storage system may include one or more energy storage devices. The method may comprise receiving, by a controller, route information, the route information including a route for the vehicle, the route including a plurality of sequential segments, and a plurality of modes for the energy storage system, each of the modes associated with travel of the vehicle along one of the segments of the route, wherein the plurality of modes includes a Charging Mode and/or a Discharging Mode; and receiving, by the controller, a vehicle speed and/or a vehicle payload. The method may further comprise determining, by the controller, an aggregate power demand required from the energy storage system during the one or more Discharging Modes on the route; determining, by the controller, an aggregate regeneration energy to be delivered to and stored by the energy storage system during the one or more Charging Modes on the route; determining, by the controller, for each segment of the route associated with the Charging Mode, an estimated charging current based at least in part on the vehicle speed and/or the vehicle payload; determining, by the controller, for each segment of the route associated with the Discharging Mode, an estimated discharging current based at least in part on the vehicle speed and/or the vehicle payload; and determining, by the controller, whether an absolute value of a slope change between a present segment of the route and a next sequential incoming segment of the route is greater than a threshold. The method may further comprise: when (a) the absolute value of the slope change is greater than the threshold and (b) the next sequential incoming segment is an uphill segment, initiating, by the controller: a first ramp-up procedure based on the estimated discharging current associated with the next sequential incoming segment and a preparation time, wherein the first ramp-up procedure includes increasing a compressor speed of a compressor of a refrigeration circuit configured to cool the one or more energy storage devices to a first temperature; and when (c) the absolute value of the slope change is less than or equal to the threshold and (d) the next sequential incoming segment is a downhill segment, initiating, by the controller: a second ramp-up procedure based on the estimated charging current associated with the next sequential incoming segment and a preparation time, wherein the second ramp-up procedure includes changing the compressor speed to a second temperature, wherein the second temperature is different than the first temperature, wherein the preparation time is the time for the vehicle to travel from the present segment to the next sequential incoming segment.

In another aspect of the disclosure, a system for regulating an operating temperature of an energy storage system configured to provide power to a vehicle is disclosed, the energy storage system including one or more energy storage devices. The system may comprise: a TMS and a controller. The TMS including a refrigeration cooling circuit configured to cool the temperature of the one or more energy storage devices, the refrigeration cooling circuit including a compressor. The controller may be configured to: receive route information, the route information including a route for the vehicle, the route including a plurality of sequential segments, and a plurality of modes for the energy storage system, each of the modes associated with travel of the vehicle along one of the segments of the route, wherein the plurality of modes includes a Charging Mode and/or a Discharging Mode; receive a vehicle speed and/or a vehicle payload; determine an aggregate power demand required from the energy storage system during the one or more Discharging Modes on the route; determine an aggregate regeneration energy to be delivered to and stored by the energy storage system during the one or more Charging Modes on the route; determine for each segment of the route associated with the Charging Mode, the estimated charging current based at least in part on the vehicle speed and/or the vehicle payload; determine for each segment of the route associated with the Discharging Mode, the estimated discharging current based at least in part on the vehicle speed and/or the vehicle payload; determine whether an absolute value of a slope change between a present segment of the route and a next sequential incoming segment of the route is greater than a threshold; when (a) the absolute value of the slope change is greater than the threshold and (b) the next sequential incoming segment is an uphill segment, initiate a first ramp-up procedure based on the estimated discharging current associated with the next sequential incoming segment and a preparation time, wherein the first ramp-up procedure includes increasing a compressor speed of a compressor of a refrigeration circuit configured to cool the one or more energy storage devices to a first temperature; and when (c) the absolute value of the slope change is less than or equal to the threshold and (d) the next sequential incoming segment is a downhill segment, initiate a second ramp-up procedure based on the estimated charging current associated with the next sequential incoming segment and a preparation time, wherein the second ramp-up procedure includes changing the compressor speed to a second temperature, wherein the second temperature is different than the first temperature, wherein the preparation time is the time for the vehicle to travel from the present segment to the next sequential incoming segment.

In yet another aspect of the disclosure, a controller for regulating an operating temperature of an energy storage system, the energy storage system including one or more energy storage devices is disclosed. The controller may be configured to receive route information, the route information including a route for a vehicle, the route including a plurality of sequential segments, and a plurality of modes for the energy storage system, each of the modes associated with travel of the vehicle along one of the segments of the route, wherein the plurality of modes includes a Charging Mode and/or a Discharging Mode; receive a vehicle speed and/or a vehicle payload; determine an aggregate power demand required from the energy storage system during the one or more Discharging Modes on the route; determine an aggregate regeneration energy to be delivered to and stored by the energy storage system during the one or more Charging Modes on the route; determine for each segment of the route associated with the Charging Mode, the estimated charging current based at least in part on the vehicle speed and/or the vehicle payload; determine for each segment of the route associated with the Discharging Mode, the estimated discharging current based at least in part on the vehicle speed and/or the vehicle payload; determine whether an absolute value of a slope change between a present segment of the route and a next sequential incoming segment of the route is greater than a threshold; when (a) the absolute value of the slope change is greater than the threshold and (b) the next sequential incoming segment is an uphill segment, initiate a first ramp-up procedure based on the estimated discharging current associated with the next sequential incoming segment and a preparation time, wherein the first ramp-up procedure includes increasing a compressor speed of a compressor of a refrigeration circuit configured to cool the one or more energy storage devices to a first temperature; and when (c) the absolute value of the slope change is less than or equal to the threshold and (d) the next sequential incoming segment is a downhill segment, initiate a second ramp-up procedure based on the estimated charging current associated with the next sequential incoming segment and a preparation time, wherein the second ramp-up procedure includes changing the compressor speed to a second temperature, wherein the second temperature is different than the first temperature, wherein the preparation time is the time for the vehicle to travel from the present segment to the next sequential incoming segment.

### BRIEF DESCRIPTION OF THE DRAWINGS

FIG. 1 is a perspective view of an exemplary machine that incorporates an Thermal Management System (TMS) according to the present disclosure;

FIG. 2 is a block diagram of an embodiment of a vehicle system of the exemplary machine of FIG. 1; and

FIG. 3 is a block diagram of an embodiment of an exemplary TMS;

FIG. 4 is an exemplary route for a vehicle at a worksite;

FIG. 5 is an exemplary worksite;

FIG. 6 is a flow diagram of one exemplary method, according to the present disclosure.

### DETAILED DESCRIPTION

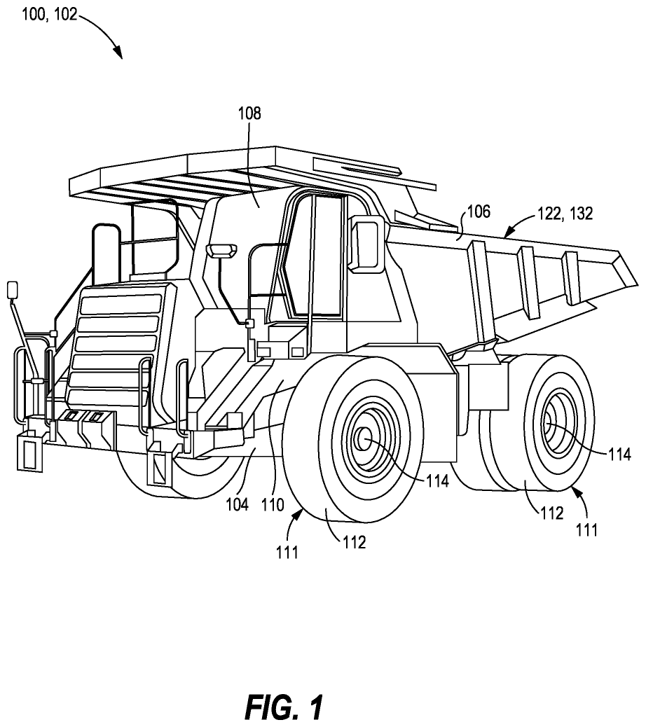

Reference will now be made in detail to specific embodiments or features, examples of which are illustrated in the accompanying drawings. Generally, corresponding reference numbers will be used throughout the drawings to refer to the same or corresponding parts, unless otherwise specified. FIG. 1 illustrates one example of a vehicle 100 that incorporates the features of the present disclosure. The exemplary vehicle 100 may be a mining truck 102 or a wheeled tractor scraper. While the following detailed description and drawings are made with reference to a mining truck 102, the teachings of this disclosure are not limited to mining trucks 102 and may be employed on other vehicles 100.

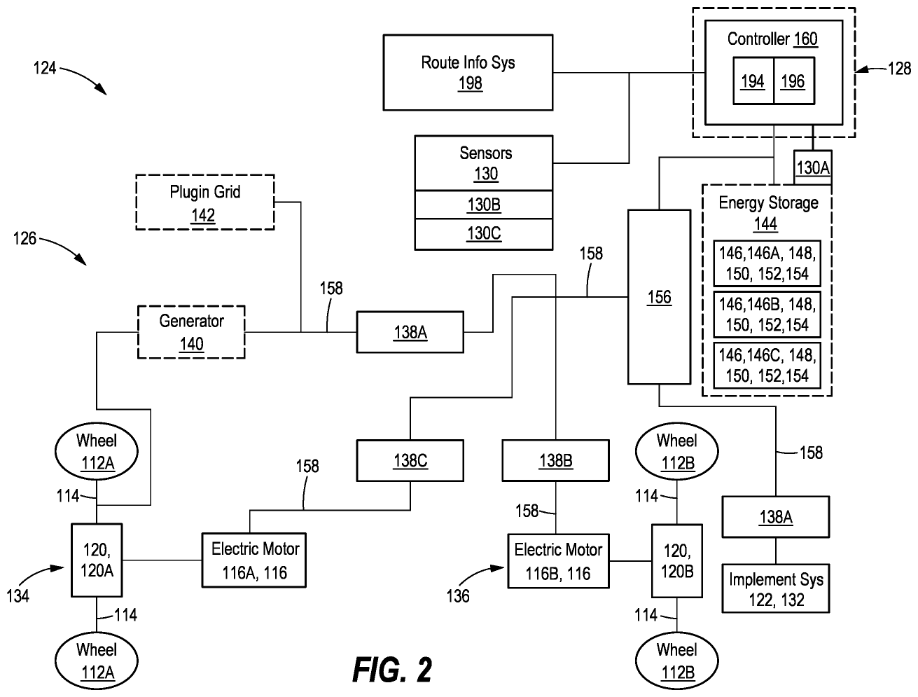

The mining truck 102 may include a frame 104. A material carrying dump body 106 may be pivotally coupled to the frame 104. Further an operator cab 108 may be mounted to the frame 104, e.g., above an enclosure 110. The mining truck 102 may be supported on the ground by a plurality of traction members 111. In the exemplary embodiment, the traction member 111 includes a plurality of wheels 112 mounted on an axle 114. A person of ordinary skill in the art will appreciate that one or more electric motors 116 (best seen in FIG. 2) and energy storage devices 146 may be disposed on the vehicle 100 and may provide power to the wheels 112, powertrain 120 (best seen in FIG. 2) and implement system(s) 122 of the vehicle 100.

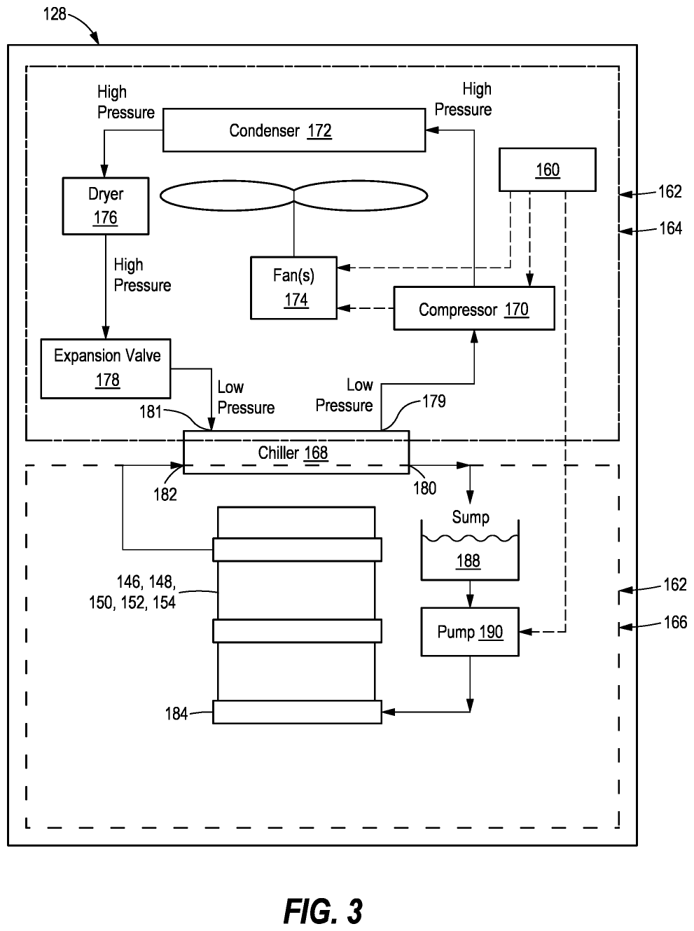

Turning now to FIG. 2 an exemplary vehicle system 124 is shown. The vehicle system 124 includes a power generation system 126 and a Thermal Management System (TMS) 128. The vehicle system 124 may include one or more sensors 130. The vehicle system 124 may include an implement system 122. For example, for the mining truck 102 of FIG. 1, the implement system 122 may include a truck bed system 132. Whereas, for a vehicle 100 that is a tractor scraper, the implement system 122 may include a bowl system. In FIG. 2, only the controller 160 of the TMS 128 is shown. FIG. 3 illustrates the TMS 128 more fully.

The exemplary power generation system 126 illustrated in FIG. 2 may include a front drive 134, which includes a first electric motor 116A in operable communication with a first powertrain 120A that is coupled to a pair of front wheels 112A via axles 114. The first powertrain 120A includes a plurality of transfer gears (not shown). The first electric motor 116A is configured to provide power to the first powertrain 120A, and is also configured to generate power during regenerative braking of the front drive.

The power generation system 126 of FIG. 2 may further include a rear drive 136, which includes a second electric motor 116B in operable communication with a second powertrain 120B that is coupled to a pair of rear wheels 112B via axles 114. The second powertrain 120B includes a plurality of transfer gears (not shown). The second electric motor 116B is configured to provide power to the second powertrain 120B and is configured to drive the rear wheels 112B via the second powertrain 120B, and is also configured to capture retarding energy through regenerative braking of the rear drive 136.

The power generation system 126 may further include one or more inverters 138. For example, in the exemplary power generation system 126, there are three separate invertors, 138A, 138B and 138C, alternatively there may be one centralized inverter 138.

The power generation system 126 of FIG. 2 may optionally include a power generator 140 in communication with a first powertrain 120A. The optional power generator 140 may be configured to provide a portion of its output power to drive the front wheels 112A via a plurality of transfer gears (not shown). In an embodiment, a portion of the output power of optional power generator 140 may be supplied to a charge system 156 via electric bus 158. The power generation system 126 of FIG. 2 may be configured to optionally receive power input from a plug-in (power) grid 142, and provide electric power to the charge system 156 via electric bus 158.

The power generation system 126 of FIG. 2 may further include an (electric) energy storage system 144 configured to provide power to the electric motors 116, the implement system 122 or other systems or components of the vehicle 100, and/or is configured to store energy captured, for example, through regenerative braking of the vehicle 100. The (electric) energy storage system 144 may include one or more energy storage devices 146 (A,B,C). Each energy storage device 146 may be or may include: one battery 148 or a plurality of batteries 148; or one capacitor 150 or a plurality of capacitors 150; or a mix of one or more batteries 148 and one or more capacitors 150. A plurality of batteries may be referred to as a battery pack 152. A plurality of capacitors may be referred to as a capacitor pack 154. In the exemplary power generation system 126 of FIG. 2, the (electric) energy storage system 144 includes three battery packs 152.

The power generation system 126 of FIG. 2 may further include the charge system 156. The charge system 156 may be configured to set cut-off voltages. The charge system 156 is configured to control battery 148/capacitor 150 discharging and/or charging activities by enabling or disabling the electric connection between a battery 148/battery pack 152 (or a capacitor 150/capacitor pack 154) and an inverter 138 or electric bus 158.

FIG. 3 illustrates an exemplary embodiment of the TMS 128. The TMS includes the electric storage management (ESM) controller (also referred to herein as “controller”) 160 and the one or more cooling circuits 162. In the exemplary embodiment, the cooling circuits 162 include a refrigeration cooling circuit 164 and a fluid cooled circuit 166.

The refrigeration cooling circuit 164 of the TMS 128 may include a chiller 168, a compressor 170, a condenser 172, a fan 174 configured to be controlled by the controller 160 (e.g., by using compressor 170 discharge pressure), a dryer 176, and an expansion valve 178.

The chiller 168 has an output port 179 through which it provides refrigerant to the compressor 170 and an input port 181 through which it receives refrigerant from the expansion valve 178. The chiller 168 is also configured to receive hot coolant from the conduit 184 of the fluid cooled circuit 166 via input port 182 and to discharge cool coolant to a sump 188 or reservoir via output port 180. Such conduit 184 is configured to carry coolant and is disposed adjacent to the energy storage device 146 (in the exemplary embodiment, a battery pack 152).

The compressor 170 is in fluid communication with the output port 179 of the chiller 168 and with an input of the condenser 172. The compressor 170 is configured to receive refrigerant from the chiller 168 as a low-pressure vapor via the output port 179 and to compress the refrigerant to a high-pressure vapor, causing it to become superheated. The condenser 172 is in further fluid communication with the dryer 176. The condenser 172 is configured to receive refrigerant as a high-pressure vapor from the compressor 170. As is known in the art, the refrigerant in high-pressure form enters the condenser 172 and flows through conduits (not shown) of the condenser 172. As the hot high-pressure vapor flows through the condenser 172, cool air is blown across the conduits by the fan 174. Because of the air blown across such conduits heat transfers from the hot refrigerant carried in such conduits to the walls of the conduits and then to the cool air moving across the surface of such conduits of the condenser 172. This heat transfer causes the hot vapor refrigerant to change state from a high pressure vapor to a high-pressure liquid. Once the refrigerant is in the high-pressure liquid state, it flows out of the condenser 172 to the dryer 176. The dryer 176 is a filtering unit located on the high-pressure side of the refrigerant loop between the condenser 172 and the expansion valve 178. The role of the dryer 176 is to filter particles and debris flowing in the circuit as well as to absorb any moisture. Furthermore, the dryer 176 is also designed to store excess refrigerant liquid. Refrigerant flows from the dryer 176 to the expansion valve 178 which is configured to maintain high-pressure on the inlet side of the expansion valve 178, while also expanding the liquid refrigerant and lowering the pressure on the outlet side of the expansion valve 178. During the process of expansion, the temperature of the liquid refrigerant is also reduced to a cool, low-pressure liquid state. The refrigerant is now ready to enter the chiller 168. The cool liquid refrigerant leaves the expansion valve 178 and enters the chiller 168 via the input port 181. Inside the chiller 168, cool liquid refrigerant absorbs heat out of hot coolant, and becomes low-pressure superheated vapor.

The coolant conduits 184 are disposed adjacent to the energy storage device 146 (e.g., battery pack 152). In the exemplary embodiment in which the energy storage device 146 comprises one or more battery packs 152, the cold coolant in the coolant conduits 184 absorbs the heat out of the warmer surface of the batteries 148 in the battery pack(s) 152, reducing the temperature of the battery (ies) 148. The hot coolant in the coolant conduits 184 flows to the chiller 168 and begins to be cooled, thus changing from a high temperature coolant to a low-temperature coolant. The fluid cooled circuit 166 includes the chiller 168, the sump 188, a pump 190 and coolant conduits 184. The sump 188 is configured to receive coolant from the chiller 168. The pump 190 is configured to draw coolant out of the sump 188 and pump such coolant through the coolant conduits 184. A portion of the coolant conduits 184 are disposed adjacent to the energy storage devices 146 and remove heat from the energy storage devices 146 via heat transfer from the surface of the energy storage devices 146 to the coolant in the coolant conduits 184. Coolant flows from the coolant conduits 184 into the chiller 168 via input port 182.

The controller 160 is in operable communication with the one or more sensors 130 (FIG. 2) on the vehicle 100. The sensors 130 may include, but are not limited to, temperature sensors 130A, speed sensors 130B, and/or load sensors 130C. The temperature sensor(s) 130A are configured to measure and provide data indicative of the temperature of the energy storage system 144 and/or energy storage device(s) 146. The controller 160 is configured to receive temperature data measured by the temperature sensor(s) 130A.

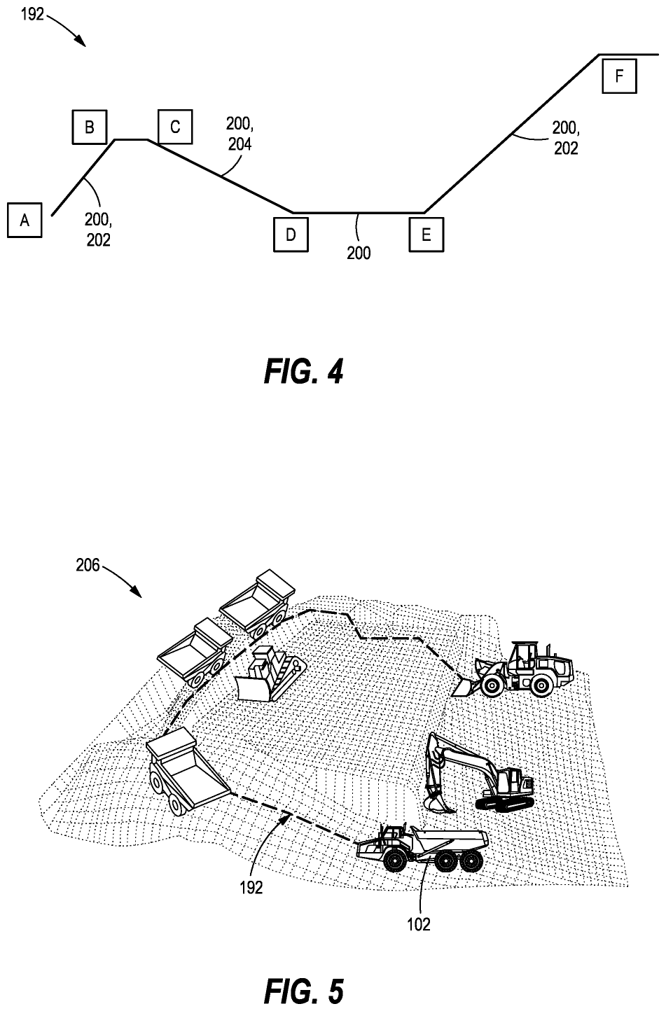

The one or more speed sensors 130B are configured to measure and provide data indicative of the travel speed of the vehicle 100 on the route 192 (FIG. 4). The controller 160 (FIG. 2) is configured to receive speed data measured by the speed sensor(s) 130B. The one or more load sensors 130C are configured to measure and provide payload data indicative of the weight of the load the vehicle 100 is carrying on the route 192. The controller 160 is configured to receive such payload data measured by the load sensor(s) 130C.

The controller 160 is configured to receive route information from a route information system 198, such as a route information site system or a fleet management system or the like. The controller 160 may be configured to adjust the speed of the compressor 170 and/or fan 174. The controller 160 may include a processor 194 and a memory component 196. The controller 160 is in operable communication with the route information system 198, the compressor 170, and the pump 190. The controller may be in communication directly or indirectly (via another system or another controller) with the sensors 130. In some embodiments, the controller may also be in communication with the fan 174.

The processor 194 may be a microcontroller, a digital signal processor (DSP), an electronic control module (ECM), an electronic control unit (ECU), a microprocessor or any other suitable processor 194 as known in the art. The processor 194 may execute instructions and generate control signals for initiating ramp-up procedures for the Discharging Mode and for the Charging Mode, e.g., increasing or decreasing compressor speed. Such instructions may be read into or incorporated into a computer readable medium, such as the memory component 196 or provided external to the processor 194. In alternative embodiments, hard wired circuitry may be used in place of, or in combination with, software instructions to implement a control method.

The term “computer readable medium” as used herein refers to any non-transitory medium or combination of media that participates in providing instructions to the processor 194 for execution. Such a medium may comprise all computer readable media except for a transitory, propagating signal. Common forms of computer-readable media include, for example, a flexible disk, hard disk, magnetic tape, or any other magnetic medium, a CD-ROM, any other optical medium, or any other computer readable medium.

The controller 160 is not limited to one processor 194 and memory component 196. The controller 160 may include several processors 194 and memory components 196. In an embodiment, the processors 194 may be parallel processors 194 that have access to a shared memory component(s) 196. In another embodiment, the processors 194 may be part of a distributed computing system in which a processor 194 (and its associated memory component 196) may be located remotely from one or more other processor(s) 194 (and associated memory components 196) that are part of the distributed computing system. The controller 160 may also be configured to retrieve from the memory component 196 data necessary for the actions discussed herein.

Also disclosed is a method of regulating a temperature of an energy storage system 144 configured to provide power to a vehicle 100. The method may comprise: receiving, by a controller 160, route information, the route information including a route 192 for the vehicle 100, the route 192 including a plurality of sequential segments 200, and a plurality of modes for the energy storage system 144, each of the modes associated with travel of the vehicle 100 along one of the segments 200 of the route 192, wherein the plurality of modes includes a Charging Mode and/or a Discharging Mode; and receiving, by the controller 160, a vehicle speed and/or a vehicle payload. The method 600 may further comprise determining, by the controller 160, an aggregate power demand required from the energy storage system 144 during the one or more Discharging Modes on the route 192; determining, by the controller 160, an aggregate regeneration energy to be delivered to and stored by the energy storage system 144 during the one or more Charging Modes on the route 192; determining, by the controller 160, for each segment 200 of the route 192 associated with the Charging Mode, an estimated charging current based at least in part on the vehicle speed and/or the vehicle payload; determining, by the controller 160, for each segment 200 of the route 192 associated with the Discharging Mode, an estimated discharging current based at least in part on the vehicle speed and/or the vehicle payload; and determining, by the controller 160, whether an absolute value of a slope change between a present segment 200 of the route 192 and a next sequential incoming segment 200 of the route 192 is greater than a threshold. The method 600 may further comprise: when (a) the absolute value of the slope change is greater than the threshold and (b) the next sequential incoming segment 200 is an uphill segment 202, initiating, by the controller 160: a first ramp-up procedure based on the estimated discharging current associated with the next sequential incoming segment 200 and a preparation time, wherein the first ramp-up procedure includes increasing a compressor speed of a compressor 170 of a refrigeration circuit 164 configured to cool the one or more energy storage devices 146 to a first temperature; and when (c) the absolute value of the slope change is less than or equal to the threshold and (d) the next sequential incoming segment 200 is a downhill segment 204, initiating, by the controller 160: a second ramp-up procedure based on the estimated charging current associated with the next sequential incoming segment 200 and a preparation time, wherein the second ramp-up procedure includes changing the compressor speed to a second temperature, wherein the second temperature is different than the first temperature, wherein the preparation time is the time for the vehicle 100 to travel from the present segment 200 to the next sequential incoming segment 200.

### INDUSTRIAL APPLICABILITY

Most TMSs use closed-loop control with a targeted battery/capacitor temperature based on the “skin” surface temperature of the energy storage device 146 (e.g., battery pack 152 or battery 148). This control is reactive control. It takes time for such battery pack's 152 or battery's 148 skin temperature to increase. By the time a traditional TMS detects the temperature change and starts adjusting the output of the compressor 170 of the refrigeration cooling circuit 164, the vehicle 100 may be on a different segment 200 (FIG. 4) of the route 192 and load conditions may have changed, impacting cooling needs. Considering TMS design, it also takes time for the chiller 168 to take away the rejected heat via heat transfer. In summary, there is a time delay between heat generation inside an energy storage device 146 and traditional TMS response. Route information can be utilized to optimize cooling system performance which provides necessary thermal management for energy storage devices 146, e.g., batteries 148.

In general, the foregoing disclosure finds utility in vehicles 100 that utilize a TMS 128 that is configured to regulate the operating temperature of one or more energy storage devices 146. The TMS 128 disclosed herein is tuned according to the charging or discharging state of the energy storage device 146 and the vehicle's route information. When this strategy is adopted to optimize the useful life of the energy storage device 146, the vehicle 100 can switch frequently between charging and discharging states (Charging Mode and Discharging Mode). The energy storage devices 146 do not need to discharge all their energy before they are recharged.

The TMS 128 is configured to set desired temperatures T1, T2 of the energy storage device 146 for a Discharging Mode and Charging Mode when an open loop control scheme is initiated by the TMS 128. The TMS 128 is configured to initiate ramp-up measures to adjust the speed of compressor 170 and fan 174 accordingly to achieve the desired temperatures T1/T2 that are set by the TMS 128 based at least in part on pre-determined calibration maps and/or parameters. For example, the TMS 128 may increase the cooling capability of the chiller 168 by increasing the speed of the compressor 170 and the speed of fan 174 in order to proactively cool the energy storage device 146 and achieve the desired temperature T1 before the vehicle 100 starts traveling on a uphill segment 202 of a route 192, in which the energy storage device 146 generates a large amount of heat in a Discharging Mode that may lead to a high temperature and may negatively impact near and long-term performance if the TMS 128 does not prepare for the thermal event in advance.

In another example, the TMS 128 may adjust the cooling capability of the chiller 168 by adjusting the speed of the compressor 170 and the speed of fan 174 in order to achieve the desired temperature T2 of the energy storage device 146 before the vehicle 100 starts traveling on a downhill segment 204 of a route 192, in which the energy storage device 146 is in a Charging Mode.

Such measures and the desired temperature T1 and T2 may be based on one or more calibration maps and an estimated amount of discharging/charging current that will flow from/to the energy storage devices 146 at an upcoming future time on the route 192 (referred to herein as an “incoming current” (value) since it will occur at the upcoming future time at a future position on the route 192), and the vehicle 100 speed and/or payload. In an exemplary embodiment, a calibration map may be a two-dimensional look-up table for a desired temperature T1, T2 with an electric current value as one dimension and a time value (e.g., maximum preparation time t1, t2) as another dimension. In an example, TMS 128 may be configured to select from the calibration map (e.g., table) or derive a value for the desired temperature T1 based on the incoming current and a preparation time (e.g., the maximum preparation time t1, which is the time used by the vehicle 100 to travel at the vehicle speed and/or payload from its current position on the route 192 to the beginning of the uphill segment 202 in the route 192).

In another example, TMS 128 may be configured to select from the calibration map (e.g., table) or derive a value for the desired temperature T2 based on the incoming current and a preparation time (e.g., the maximum preparation time t2, which is the time used by the vehicle 100 to travel at the vehicle speed and/or payload from its current position to the beginning of the downhill segment 204 on the route 192). In this way, the operating temperature of the energy storage device 146 may be maintained within a desired operating range and temperature peaks can be effectively avoided or smoothed. By avoiding rapid temperature variations, the useful life of the energy storage device 146 increases.

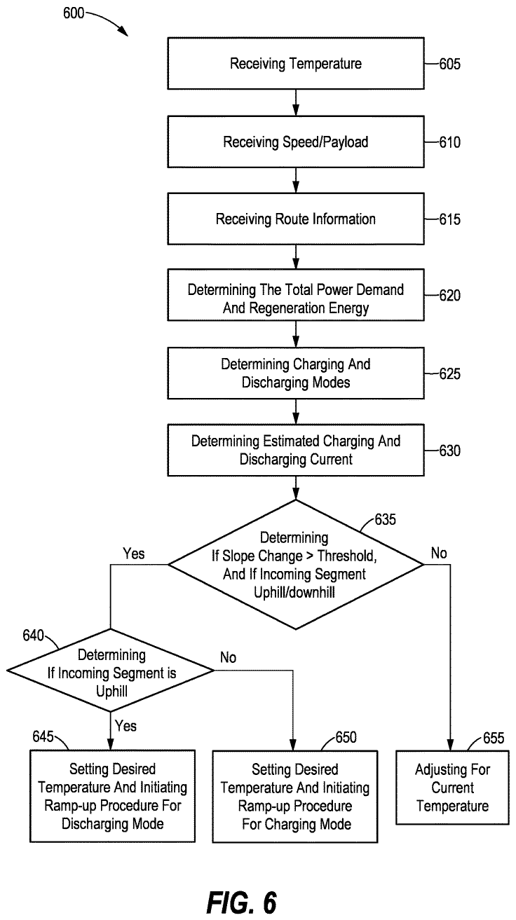

In operation, the controller 160 may be configured to operate according to a method 600, as shown for example in FIG. 6. FIG. 6 is an exemplary flowchart illustrating sample blocks which may be followed in a method 600 of regulating an operation temperature of an energy storage device 146. In the exemplary flow chart the method 600 is discussed in relation to a battery 148 or battery pack 152, however the method 600 may also be utilized with capacitors 150, capacitor packs 154 or a combination of battery (ies) 148 and capacitor(s) 150.

Block 605 includes receiving, by the controller 160 (FIG. 2), temperature data associated with the energy storage device(s) 146. The temperature data may include a temperature that may be measured on the skin of the energy storage device 146 or in the energy storage device 146 by one or more temperature sensors 130A. Temperature data that includes such temperature may be received directly or indirectly by the controller 160 from the temperature sensors 130A or from another controller or system.

Block 610 includes receiving, by the controller 160, speed data that includes the vehicle speed, and/or receiving, by the controller 160, vehicle payload data that includes (the amount of) vehicle payload. The vehicle speed may be measured by one or more speed sensors 130B, as is known in the art. Speed data that includes the vehicle speed may be received directly or indirectly from such speed sensors 130B or another controller or system. The vehicle payload may be measured by one or more load sensors 130C, as is known in the art. Payload data that includes (the amount of) payload of the vehicle 100 and may be received directly or indirectly from the load sensors 130C or another controller or system.

Block 615 may include receiving, by the controller 160, route information for the route 192 (FIG. 4) at a worksite 206 (FIG. 5) for the vehicle 100. The route information may be received from a route information system 198 (FIG. 2) in communication with the controller 160. The route information includes the route 192 (FIG. 5) along which the vehicle 100 will travel and other potential hazardous information along the route 192. The hazardous information may be created in a site assessment process or according to industrial standards. The hazardous information includes, but is not limited to, a pitfall hazard due to extraction of material, a mechanical hazard due to dumping or undercutting material, slippery route surface condition due to weather change, abandoned trenches, and/or the like. The route information may also include one or more parameters associated with the terrain and/or geography of the route 192 at the worksite 206. A non-exhaustive list of route parameters includes, but is not limited to, latitude, longitude, altitude/height, length of the segments, slope of segments, etc. As shown in FIG. 4, the route 192 may include a plurality of sequential segments 200. Each mode is associated with travel of the vehicle 100 along one of the segments 200 of the route 192. The modes may include, but are not limited to, Discharging Mode and Charging Mode. When traveling on an uphill or generally inclined segment 200 (an “uphill segment” 202) of a route 192, current will be discharged from the energy storage device(s) 146 to provide power to the vehicle electric motors 116 (FIG. 2) that drive the front wheel 112 and/or rear wheels 112. When the energy storage device(s) 146 are discharging, the energy storage system 144 (and energy storage device(s) 146) is in the “Discharging Mode.” When traveling on downhill or generally downward sloped segment 200 (a “downhill segment” 204) of a route 192 (FIG. 4), retarding energy from regenerative braking of the front or rear drives 134, 136 in the form of captured charging current is stored in the energy storage device(s) 146. When the energy storage device(s) 146 are charging, the energy storage system 144 (and energy storage device(s) 146) is in the “Charging Mode.”

FIG. 4 illustrates an exemplary route 192 extending from a starting point A to the destination point F. In the route illustrated in FIG. 4, there are five segments 200 between the starting point A and the destination point F (the first segment 200 extends from A to B, the second segment 200 extends from B to C, the third segment 200 extends from C to D, the fourth segment 200 extends from D to E and the fifth segment 200 extends from E to F). The energy storage device(s) 146 (FIG. 2) are in a Discharging Mode during travel on uphill segments 202 A to B and E to F (see FIG. 4), and are in Charging Mode during travel on the downhill segment 204 that extends C to D.

In FIG. 4, different segments 200 are shown as having different lengths. In another embodiment, each segment 200 may have the same length, e.g., 1000 meters or 10,000 meters. Segment 200 delineation may be based on the slope change of segments 200 or other geographic characteristics of segments 200.

Block 620 includes determining, by the controller 160, the total (aggregate) power demand from the energy storage device(s) 146 during the Discharging Modes (segments 202, A to B and E to F) occurring during the traveling of the vehicle 100 on the route 192 (A to F), and the total (aggregate) regeneration energy delivered to and stored in the energy storage devices 146 during the Charging Modes (in the exemplary scenario during the traveling of the vehicle 100 on segment 200, 204 C to D).

Block 625 includes determining, by the controller 160, the segments 200 on the route 192 where the vehicle 100 will be in the Charging Mode (due to regenerative braking or the like on a downhill segment 204) and the segments 200 on the route 192 in which the vehicle 100 will be in the Discharging Mode (due to power demand on an uphill segment 202) along the route 192. A person of ordinary skill in the art will appreciate that all mode switching points along the route 192 may be derived when the vehicle 100 receives its payload at point A considering a series of site operation requirements including, but not limited to, weather condition, site surface or road surface condition, known hazards and recommended speed on each segment 200 of the route 192.

Block 630 includes determining, by the controller 160, for each segment 200 of the route 192 (uphill segment 202) for which the power generation system 126 is in Discharging Mode, the estimated discharging current based on the (a) route information and (b) vehicle speed and/or payload. Block 630 further includes determining, by the controller 160, for each segment 200 of the route 192 (downhill segment 204) for which the power generation system 126 is in Charging Mode, the estimated charging current based on the (a) route information and (b) vehicle speed and/or payload.

Block 635 includes determining, by the controller 160, whether a slope change between the present segment 200 (the “presently traveled segment”) of the route 192 and the incoming segment 200 of the route 192 is greater than a threshold, and whether the incoming segment 200 is one of uphill and downhill segments 200. If (a) the absolute value of the slope change is greater than the threshold, and (b) the incoming segment 200 is either an uphill segment 202 or a downhill segment 204, the method 600 proceeds to block 640, and thereafter, initiates an open-loop control process. If (a) the absolute value of the slope change is equal to or less than the threshold, or (b) incoming segment 200 is not an uphill segment 202 or is not a downhill segment, the method 600 proceeds to block 655, and thereafter, keeps the closed-loop control process. In one example, when traveling on the fourth segment 200 (D to E), the current slope of segment 200 is within 0°+/−3 degrees, but the incoming slope of the next subsequent segment 200 (fifth segment E to F) will be 50°+/−3 degrees, which is different from the current slope and the absolute value of the difference is greater than a threshold (e.g., 10 degrees). In another example, when traveling on the second segment 200 (B to C) the current slope is within 0+/−3 degrees, but the incoming slope on the next subsequent segment 200 (third segment C to D) will be −20°+/−3 degrees, which is different from the current slope and the absolute value of the difference is greater than the threshold (e.g., 10 degrees). In both examples, the method 600 proceeds to block 640.

In block 640, the method 600 includes determining, by the controller 160, whether the next segment 200 of the route 192 is uphill or not. If it is an uphill segment 202, the method 600 proceeds to block 645. If no, the method 600 proceeds to block 650.

Block 645 of the method 600 includes the following actions by the controller 160: (I) setting the desired temperature T1 based on (a) the (estimated) incoming discharging current, (b) the preparation time and (c) one or more pre-determined calibration maps and/or parameters; and (II) initiating a ramp-up procedure to change the temperature of the energy storage device 146 to the desired temperature T1. As discussed earlier herein, in one exemplary embodiment, the calibration map may be a two-dimensional look-up table for the desired temperature T1 with an electric current value as one dimension and a time value (e.g., maximum preparation time t1) as another dimension. In such exemplary embodiment, TMS 128 may be configured to select from the calibration map (e.g., table) or derive a value for the desired temperature T1 based on the incoming discharging current and the preparation time (e.g., the maximum preparation time t1, which is the time used by the vehicle 100 to travel at the vehicle speed and/or payload from its current position on the route 192 to the beginning of the uphill segment 202 in the route 192). The ramp up procedure includes increasing the speed of the compressor 170 and the speed of the fan 174. Increasing the compressor 170 speed increases the discharge pressure of the compressor 170. The controller may also be configured to directly increase the speed of the fan 174. An increase in the speed of the fan 174 will increase the convective heat transfer. Doing this provides increased cooling to the energy storage device 146, effectively lowering the temperature of the energy storage devices 146 and bringing the temperature to the desired temperature T1 in advance of the increasing discharge current generating heat that increases the temperature of the energy storage devices 146 to outside of the desired, or optimal, operating range. In this way, the energy storage device 146 may be cooled in advance to smooth out the temperature peak. Without rapid temperature variations on the energy storage device 146, the energy storage device use life increases.

Block 650 of the method 600 includes the following actions by the controller 160: (I) setting the desired temperature T2 based on (a) the estimated incoming charging current, (b) the preparation time and (c) one or more pre-determined calibration maps and/or parameters; and (II) initiating a ramp-up procedure to change the temperature of the energy storage device 146 to the desired temperature T2. The ramp-up procedure may include adjusting the cooling capability of the chiller 168 by changing the speed of the compressor 170 and the speed of fan 174 in order to achieve the desired temperature T2 of the energy storage device 146 before the vehicle 100 starts travelling on a downhill segment 204 of a route 192.

In block 655, the controller 160 continuously adjusts the cooling capability of the chiller 168 in a closed-loop control targeting at the desired temperature range of the energy storage device 146. The controller 160 can continuously adjust the speed of the compressor 170, or the speed of fan 174, or the output flow of the pump 190, or any combinations of them to keep the measured temperature the energy storage device 146 within an optimized range or desired range during the travelling of the vehicle 100.

A person of ordinary skill in the art will appreciate that the controller 160 will repeatedly perform the slope checking by repeatedly performing the control logic depicted in FIG. 6, and therefore, an open-loop control or closed-loop control will be determined along the route 192. From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A method of regulating a temperature of an energy storage system configured to provide power to a vehicle, the energy storage system including one or more energy storage devices, the method comprising:
receiving, by a controller, route information, the route information including a route for the vehicle, the route including a plurality of sequential segments, and a plurality of modes for the energy storage system, each of the modes associated with travel of the vehicle along one of the segments of the route, wherein the plurality of modes includes a Charging Mode and/or a Discharging Mode;
receiving, by the controller, a vehicle speed and/or a vehicle payload;
determining, by the controller, an aggregate power demand required from the energy storage system during the one or more Discharging Modes on the route;
determining, by the controller, an aggregate regeneration energy to be delivered to and stored by the energy storage system during the one or more Charging Modes on the route;
determining, by the controller, for each segment of the route associated with the Charging Mode, an estimated charging current based at least in part on the vehicle speed and/or the vehicle payload;
determining, by the controller, for each segment of the route associated with the Discharging Mode, an estimated discharging current based at least in part on the vehicle speed and/or the vehicle payload;
determining, by the controller, whether an absolute value of a slope change between a present segment of the route and a next sequential incoming segment of the route is greater than a threshold;
when (a) the absolute value of the slope change is greater than the threshold and (b) the next sequential incoming segment is an uphill segment, initiating, by the controller: a first ramp-up procedure based on the estimated discharging current associated with the next sequential incoming segment and a preparation time, wherein the first ramp-up procedure includes increasing a compressor speed of a compressor of a refrigeration circuit configured to cool the one or more energy storage devices to a first temperature; and
when (c) the absolute value of the slope change is less than or equal to the threshold and (d) the next sequential incoming segment is a downhill segment, initiating, by the controller: a second ramp-up procedure based on the estimated charging current associated with the next sequential incoming segment and a preparation time, wherein the second ramp-up procedure includes changing the compressor speed to a second temperature, wherein the second temperature is different than the first temperature, wherein the preparation time is the time for the vehicle to travel from the present segment to the next sequential incoming segment.

2. The method of claim 1, wherein the energy storage device includes a battery or a battery pack.

3. The method of claim 1, wherein the energy storage device includes a capacitor or a capacitor pack.

4. The method of claim 1, wherein the energy storage system is further configured to provide power to one or more implement systems of the vehicle.

5. The method of claim 1, wherein the vehicle is a mining truck.

6. The method of claim 1, wherein the aggregate power demand required from the energy storage system is a sum of the power demand for travel of the vehicle on each segment associated with the Discharging Mode.

7. The method of claim 1, wherein the aggregate regeneration energy to be delivered to and stored by the energy storage system is a sum of the energy estimated to be stored during travel of the vehicle on each segment associated with the Charging Mode.

8. A system for regulating an operating temperature of an energy storage system configured to provide power to a vehicle, the energy storage system including one or more energy storage devices, the system comprising:
a TMS that includes a refrigeration cooling circuit configured to cool the temperature of the one or more energy storage devices, the refrigeration cooling circuit including a compressor,
a controller configured to:
receive route information, the route information including a route for the vehicle, the route including a plurality of sequential segments, and a plurality of modes for the energy storage system, each of the modes associated with travel of the vehicle along one of the segments of the route, wherein the plurality of modes includes a Charging Mode and/or a Discharging Mode;
receive a vehicle speed and/or a vehicle payload;
determine an aggregate power demand required from the energy storage system during the one or more Discharging Modes on the route;
determine an aggregate regeneration energy to be delivered to and stored by the energy storage system during the one or more Charging Modes on the route;
determine for each segment of the route associated with the Charging Mode, an estimated charging current based at least in part on the vehicle speed and/or the vehicle payload;
determine for each segment of the route associated with the Discharging Mode, an estimated discharging current based at least in part on the vehicle speed and/or the vehicle payload;
determine whether an absolute value of a slope change between a present segment of the route and a next sequential incoming segment of the route is greater than a threshold;
when (a) the absolute value of the slope change is greater than the threshold and (b) the next sequential incoming segment is an uphill segment, initiate a first ramp-up procedure based on the estimated discharging current associated with the next sequential incoming segment and a preparation time, wherein the first ramp-up procedure includes increasing a compressor speed of a compressor of a refrigeration circuit configured to cool the one or more energy storage devices to a first temperature; and
when (c) the absolute value of the slope change is less than or equal to the threshold and (d) the next sequential incoming segment is a downhill segment, initiate a second ramp-up procedure based on the estimated charging current associated with the next sequential incoming segment and a preparation time, wherein the second ramp-up procedure includes changing the compressor speed to a second temperature, wherein the second temperature is different than the first temperature, wherein the preparation time is a time for the vehicle to travel from the present segment to the next sequential incoming segment.

9. The system of claim 8, wherein the energy storage device includes a battery or a battery pack.

10. The system of claim 8, wherein the energy storage device includes a capacitor or a capacitor pack.

11. The system of claim 8, wherein the energy storage system is further configured to provide power to one or more implement systems of the vehicle.

12. The system of claim 8, wherein the vehicle is a mining truck.

13. The system of claim 8, wherein the aggregate power demand required from the energy storage system is a sum of the power demand for translation of the vehicle on each segment associated with the Discharging Mode.

14. The system of claim 8, wherein the aggregate regeneration energy to be delivered to and stored by the energy storage system is a sum of the energy estimated to be stored during translation of the vehicle on each segment associated with the Charging Mode.

15. A controller for regulating an operating temperature of an energy storage system, the energy storage system including one or more energy storage devices, the controller configured to:
receive route information, the route information including a route for a vehicle, the route including a plurality of sequential segments, and a plurality of modes for the energy storage system, each of the modes associated with travel of the vehicle along one of the segments of the route, wherein the plurality of modes includes a Charging Mode and/or a Discharging Mode;
receive a vehicle speed and/or a vehicle payload;
determine an aggregate power demand required from the energy storage system during the one or more Discharging Modes on the route;
determine an aggregate regeneration energy to be delivered to and stored by the energy storage system during the one or more Charging Modes on the route;
determine for each segment of the route associated with the Charging Mode, an estimated charging current based at least in part on the vehicle speed and/or the vehicle payload;
determine for each segment of the route associated with the Discharging Mode, an estimated discharging current based at least in part on the vehicle speed and/or the vehicle payload;
determine whether an absolute value of a slope change between a present segment of the route and a next sequential incoming segment of the route is greater than a threshold;
when (a) the absolute value of the slope change is greater than the threshold and (b) the next sequential incoming segment is an uphill segment, initiate a first ramp-up procedure based on the estimated discharging current associated with the next sequential incoming segment and a preparation time, wherein the first ramp-up procedure includes increasing a compressor speed of a compressor of a refrigeration circuit configured to cool the one or more energy storage devices to a first temperature; and
when (c) the absolute value of the slope change is less than or equal to the threshold and (d) the next sequential incoming segment is a downhill segment, initiate a second ramp-up procedure based on the estimated charging current associated with the next sequential incoming segment and a preparation time, wherein the second ramp-up procedure includes changing the compressor speed to a second temperature, wherein the second temperature is different than the first temperature, wherein the preparation time is the time for the vehicle to travel from the present segment to the next sequential incoming segment.

16. The controller of claim 15, wherein the energy storage device includes a battery or a battery pack.

17. The controller of claim 15, wherein the energy storage device includes a capacitor or a capacitor pack.

18. The controller of claim 15, wherein the vehicle is a mining truck.

19. The controller of claim 15, wherein the aggregate power demand required from the energy storage system is a sum of the power demand for travel of the vehicle on each segment associated with the Discharging Mode.

20. The controller of claim 15, wherein the aggregate regeneration energy to be delivered to and stored by the energy storage system is a sum of the energy estimated to be stored during travel of the vehicle on each segment associated with the Charging Mode.
